(19) United States
(12) Patent Application Publication
(10) Pub. No.: US 2025/0299022 A1
(43) Pub. Date: Sep. 25, 2025

(54) Machine Learning Systems and Methods for Real Time Anomaly Detection and Prescriptive Feedback

(71) Applicant: ZEBRA TECHNOLOGIES CORPORATION, Lincolnshire, IL (US)

(72) Inventors: Ross Caisse, Walpole, MA (US); Caleb Popow, Hampstead, MD (US); Mary E. Sylvia, Needham, MA (US); Jing Ren, Burlington, MA (US); Moez Ali, Toronto (CA); Anas Ahamed Ajmalkhan, Natick, MA (US); Vidya Preetha Anandamurali, Tabernacle, NJ (US)

(21) Appl. No.: 18/736,474

(22) Filed: Jun. 6, 2024

Related U.S. Application Data
(60) Provisional application No. 63/567,400, filed on Mar. 19, 2024.

(51) Int. Cl. G06N 3/0455; G06N 3/088

(52) U.S. Cl. CPC G06N 3/0455; G06N 3/088

(57) ABSTRACT

A computer-implemented method for anomaly detection comprising receiving a set of data parameters; retrieving a dataset corresponding to the set of data parameters from a database; analyzing, using a machine learning model trained in real-time, the dataset to detect one or more anomalies in the dataset; selecting a set of anomaly parameters corresponding to the detected one or more anomalies; filtering an output of the machine learning model according to the set of anomaly parameters; generating a set of instructions for identifying one or more anomalous items based on the set of data parameters, the set of anomaly parameters, and a set of detection pattern parameters; executing the set of instructions for identifying anomalous items to identify one or more anomalous items in real-time within the dataset responsive to updates to the dataset; and transmitting information about the one or more anomalous items to a user device or computing device.

### CROSS-REFERENCE TO RELATED APPLICATIONS

This application claims priority to U.S. Provisional Application No. 63/567,400, filed Mar. 19, 2024, which is incorporated herein by reference in its entirety.

### TECHNICAL FIELD

The present disclosure is generally directed to methods and systems for using machine learning models for real-time anomaly detection, generating a pattern for continuous monitoring of data, and assigning prescriptive actions in response to detecting anomalies.

### BACKGROUND

The background description provided herein is for the purpose of generally presenting the context of the disclosure. Work of the presently named inventor, to the extent it is described in this background section, as well as aspects of the description that may not otherwise qualify as prior art at the time of filing, are neither expressly nor impliedly admitted as prior art against the present disclosure.

Existing anomaly detection processes, such as those in the retail exception-based reporting, lack the ability to create new data and detect anomalies in an on-demand, real-time manner. Additionally, existing anomaly detection processes do not include converting anomaly detection into a repeated and persistent process, providing prescriptive actions for correcting the anomaly to select users based on a level of responsibility and/or security, and communicating prescriptive actions with external task management applications. Thus, there exists an opportunity for on-demand, real-time anomaly detection.

### BRIEF SUMMARY

In an implementation, a computer-implemented method for anomaly detection includes receiving, via one or more processors, a set of data parameters; retrieving, via the one or more processors, a dataset corresponding to the set of data parameters from a database; analyzing, via the one or more processors and using a machine learning model trained in real-time, the dataset to detect one or more anomalies in the dataset; selecting, via the one or more processors, a set of anomaly parameters corresponding to the detected one or more anomalies; filtering, via the one or more processors, an output of the machine learning model according to the set of anomaly parameters; generating, via the one or more processors, a set of instructions for identifying one or more anomalous items based on the set of data parameters, the set of anomaly parameters, and a set of detection pattern parameters; executing, via the one or more processors, the set of instructions for identifying anomalous items to identify one or more anomalous items in real-time within the dataset responsive to updates to the dataset; and transmitting, via the one or more processors, information about the one or more anomalous items to a user computing device or another computing device.

In one implementation, a computing system for anomaly detection includes one or more processors; and one or more memories having stored thereon computer-executable instructions that, when executed by the one or more processors, cause the computing system to: receive a set of data parameters; retrieve a dataset corresponding to the set of data parameters from a database; analyze, using a machine learning model trained in real-time, the dataset to detect one or more anomalies in the dataset; select a set of anomaly parameters corresponding to the detected one or more anomalies; filter an output of the machine learning model according to the set of anomaly parameters; generate a set of instructions for identifying one or more anomalous items based on the set of data parameters, the set of anomaly parameters, and a set of detection pattern parameters; execute the set of instructions for identifying anomalous items to identify one or more anomalous items in real-time within the dataset responsive to updates to the dataset; and transmit information about the one or more anomalous items to a user computing device or another computing device.

### BRIEF DESCRIPTION OF THE FIGURES

The figures described below depict various implementations of the system and methods disclosed therein. It should be understood that each figure depicts one implementation of a particular implementation of the disclosed system and methods, and that each of the figures is intended to accord with a possible implementation thereof. Further, wherever possible, the following description refers to the reference numerals included in the following figures, in which features depicted in multiple figures are designated with consistent reference numerals.

The figures depict preferred implementations for purposes of illustration only. One skilled in the art will readily recognize from the following discussion that alternative implementations of the systems and methods illustrated herein may be employed without departing from the principles of the invention described herein.

FIG. 1 depicts a flow diagram of an exemplary method for real time anomaly detection and prescriptive feedback using machine learning, according to some aspects.

FIGS. 2A-2B depict an example process of selecting a set of data parameters and retrieving data from a database according to the selected set of data parameters, according to some aspects.

FIGS. 3A-3B depict an example process of anomaly detection, according to some aspects.

FIGS. 4A-4B depicts an example of filtering of the results of the anomaly detection process and the reasons for the anomaly, according to some aspects.

FIG. 5 depicts an example user interface for generating a set of instructions for identifying anomalous items responsive to updates to the dataset, according to some aspects.

FIG. 6 depicts a user interface of a transmitted caught item and prescriptive actions to the appropriate user for handling the actions, according to some aspects.

FIG. 7 depicts a sequence diagram illustrating an example of executing a set of instructions for identifying anomalous items in real-time, according to some aspects.

FIGS. 8A-8B depicts an example of communicating prescriptive actions to an external task management system, according to some aspects.

FIG. 9 depicts an exemplary computing environment in which the techniques disclosed herein may be implemented, according to some aspects.

### DETAILED DESCRIPTION

### Overview

The present techniques provide systems and methods using machine learning for, inter alia, on-demand, real-time anomaly detection. The methods and systems include, for example, receiving a set of data parameters; retrieving a dataset corresponding to the set of data parameters from a database; analyzing, using a machine learning model trained in real-time, the dataset to detect one or more anomalies in the dataset; selecting a set of anomaly parameters corresponding to the detected one or more anomalies; filtering an output of the machine learning model according to the set of anomaly parameters; generating a set of instructions for identifying one or more anomalous items; executing the set of instructions for identifying anomalous items to identify one or more anomalous items in real-time within the dataset responsive to updates to the dataset; and transmitting information about the one or more anomalous items to a user computing device or another computing device.

As noted above, existing anomaly detection processes, such as those in the retail exception-based reporting, lack the ability to create new data and detect anomalies in a real-time, on-demand manner. Existing anomaly detection processes do not convert anomaly detection into a repeated and persistent process. Such limitations result in part from technical hurdles facing system providers, as well as retail customers. A particular customer may have tens, hundreds, or thousands of stores, kiosks, warehouses, distribution centers, etc. that each capture data on items, customers, and/or employees. Trying to detect anomalies in the captured data is challenging given the amount of data, the complexity of the captured data, the varying times at which the data is collected, and other factors. These technical hurdles are thus partly a result of data volume.

Yet anomaly detection, especially in areas such as retail exception-based monitoring, has a specificity hurdle. Anomaly detection systems are not capable of detecting new, previously unknown anomalies. A customer may design an executable script highly specified to detect a particular type of anomaly, but identifying anomalies in a trainable manner is not available. If an anomaly is not pre-scripted, it will likely go undetected, as a result. This failure is a particular problem for retailers facing employee theft, where unscrupulous employees continue to develop increasingly sophisticated ways of using the retailer's own computing systems to engage in undetected product theft. System designers also realize that it is exceedingly challenging to create highly-specified anomaly detection scripts and deploy them across remote locations, such as, across an entire region of retail store locations. The more specific the anomaly to be detected, the more challenging it would be to tailor that script to another location or another anomaly detection. Further, the more specific and the more localized an anomaly detection is configured, the more challenging it is to determine prescriptive action and prescribe a suitable response, especially in an on-demand manner based on real time data collection. It is all but impossible, with conventional systems, to have an on-demand, real-time anomaly detection system that can aggregate data across multiple remote locations and determine a response level for prescriptive actions, where that response level can vary from an action at a specific data entry point, such as a particular scan station in a retail location or warehouse, to actions that require supervisory level actions such as continual monitoring of an employee across different locations or across different time windows.

To overcome these technical hurdles, the present application describes systems and methods that provide on-demand, real-time anomaly detection through a machine learning model that is trained in real-time on collected data. The result is a real-time trainable anomaly detection engine. The collected data may be from one or more locations, such as remote computing systems communicating real-time data to a server, a centralized computing system, etc. having stored therein the anomaly detection engine for performing methods described herein. In various examples, the machine learning model may be an auto encoder neural network, although other example machine learning models include linear or logistic regression, instance-based algorithms, regularization algorithms, decision trees, isolation forest, Bayesian networks, cluster analysis, association rule learning, artificial neural networks, deep learning, combined learning, reinforced learning, dimensionality reduction, and support vector machines, by way of example. In such examples, the machine learning model has an architecture that is not required to be pre-trained while it is still designed for anomaly detection of real-time data. Responsive to the real-time data, anomaly detection parameters may be deployed that filter the real-time data prior to submission to the anomaly detection engine. The real-time data and the anomaly detection engine output may be deployed as a continuous detection pattern that autonomously examines for anomalies in further received real-time data. That is, the anomaly detection engine may be used to generate anomaly patterns that are monitored for. These anomaly patterns may be remote location specific, for example, where the anomaly detection engine detects possible anomalies at a particular location. These anomaly patterns may encompass a multitude of remote locations. These anomaly patterns may be location specific, item specific, item type specific, employee specific, customer specific, etc. or any combinations thereof.

Thus, the techniques of the present disclosure provide a technical improvement over conventional techniques at least by improving the functionality of a computing device (e.g., server executing machine learning model). In particular, the computing device analyzes data using a ML model trained in real-time, generates sets of instructions to identify anomalous items, and executes the instructions in a particular way that enhances the efficiency of the computing device. Performing these actions enables detection of previously unknown anomalies (i.e., unique anomalies that that a conventional system may not be able to detect) with an efficiency (i.e., in real-time) not achieved using conventional techniques. That is, the present disclosure describes improvements in the functioning of the computer itself because the computing device more efficiently identifies anomalies as a direct result of the machine learning model and the generated sets of instructions. This improves over the prior art at least because existing systems are incapable of identifying previously unknown data anomalies in real-time and/or are otherwise unable to analyze data with the efficiency resulting from the disclosed machine learning model and generated sets of instructions.

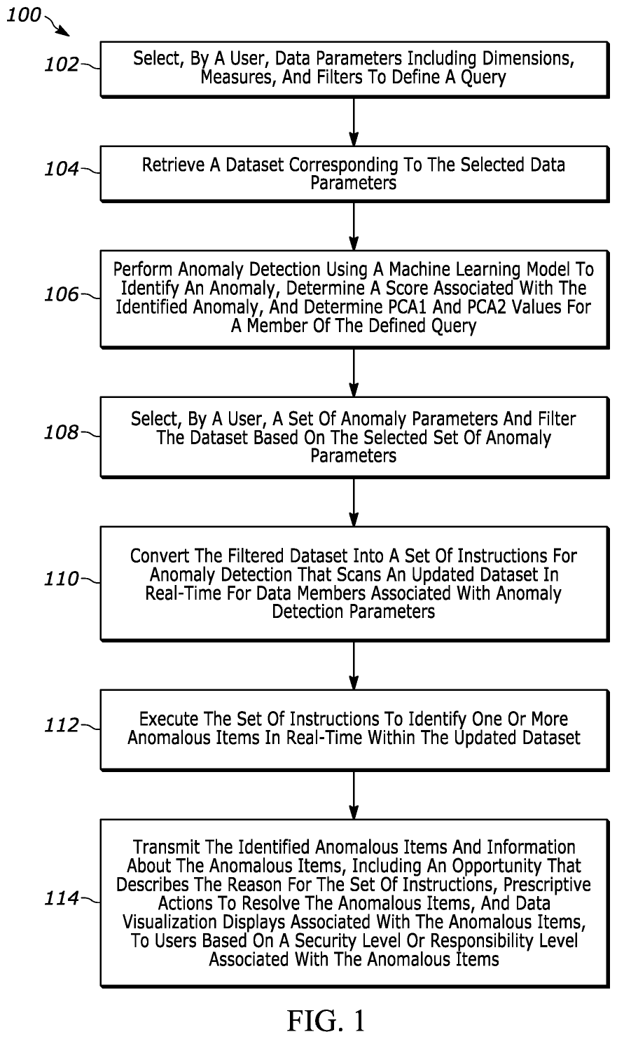

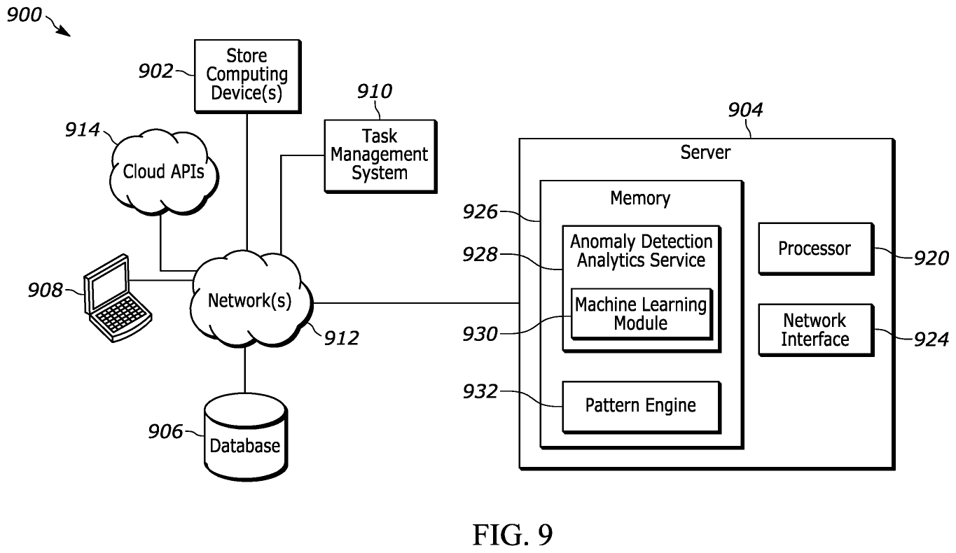

FIG. 1 is a flow diagram of a method for on-demand, real-time anomaly detection. In various examples, the methods herein may be implemented through the computing environment depicted in FIG. 9, which may include computing resources for training and/or operating machine learning models to detect anomalies. The environment may include a user device, store computing devices, task management system, server, database, and/or cloud APIs communicatively coupled via a network. A user can access an application for anomaly detection by using a desktop browser or mobile browser via a user device such as the user device 908 of FIG. 9 below.

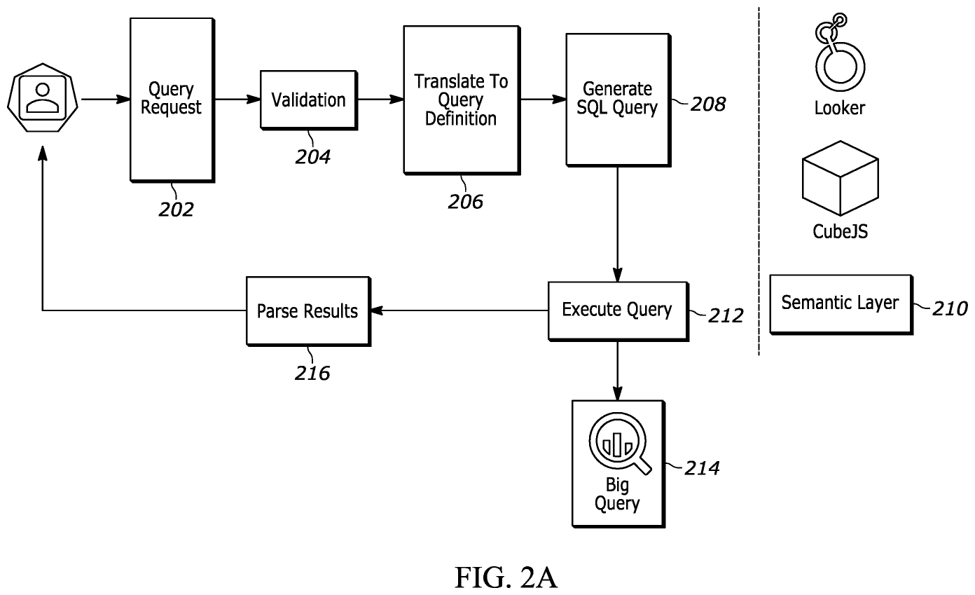

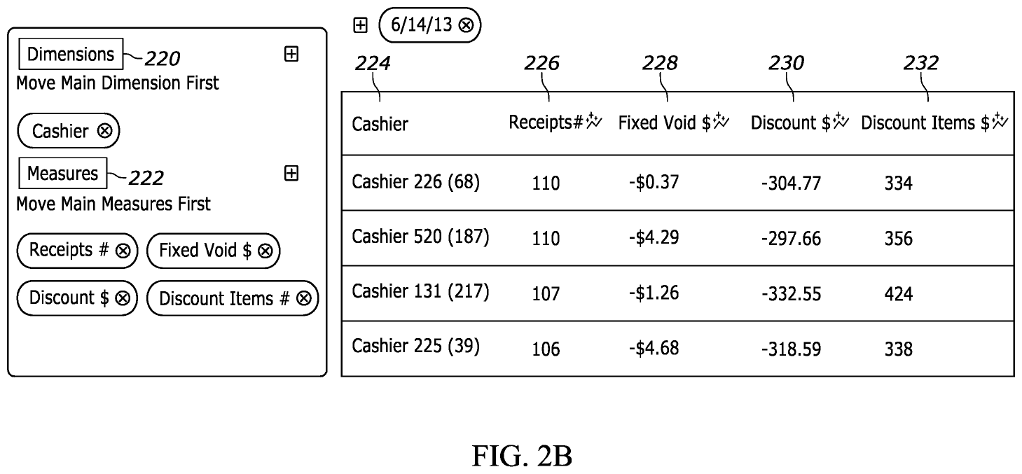

The method begins at block 102 with a user, for example, interfacing with a user device such as the device 908 of FIG. 9, which may be a smart phone, tablet, desktop computer, etc., to select a set of data parameters indicating data the system intends to analyze. The set of data parameters define a query and may include dimensions and measures. A dimension is the entity the system intends to analyze and the measures are metrics the system intends to analyze associated with the dimension. The entity may be any entity identifiable in a remote location, including, but not limited to a data collection device, system, station, or any entity associated with or operating a data collection device, system, or station at the remote location. For example, as shown in FIG. 2B, a dimension may be one or more cashiers and the measures may be the number of receipts produced by cashiers, a dollar amount of discounts applied by cashiers, a number of items discounted by cashiers, and a fixed void dollar amount for the cashiers. In another example, a dimension may be a store, and measures may include a dollar amount of a suspended transaction and a dollar amount of sales for a particular item. The data parameters may be used to construct a query to submit to a database to retrieve data.

At block 104, a dataset may be retrieved from a database according to the data parameters by submitting the constructed query to the database. The database may be a cloud database such as Google BigQuery.

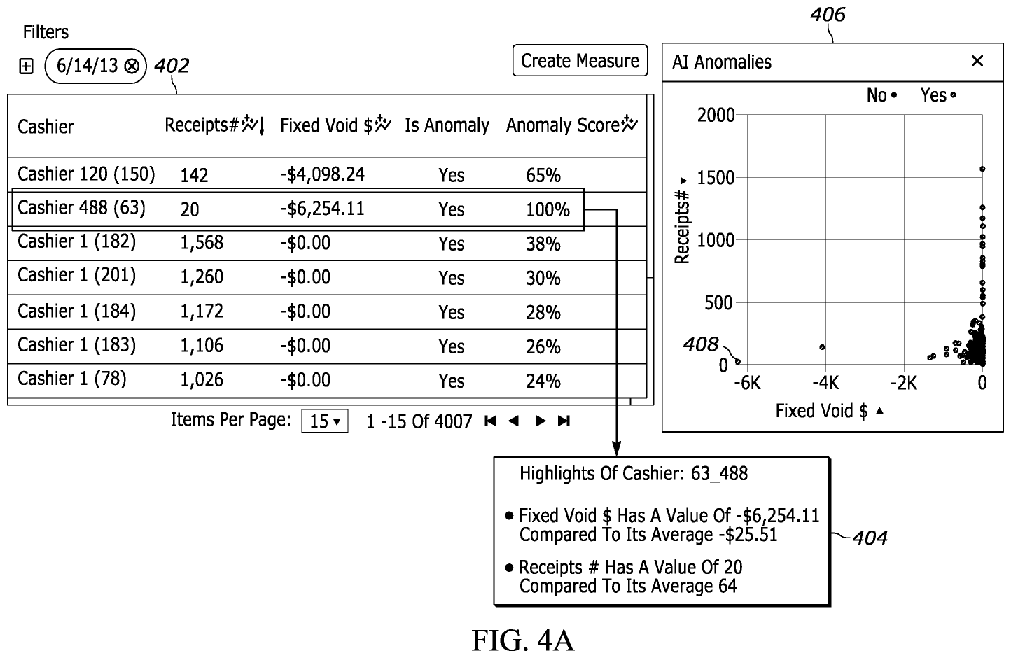

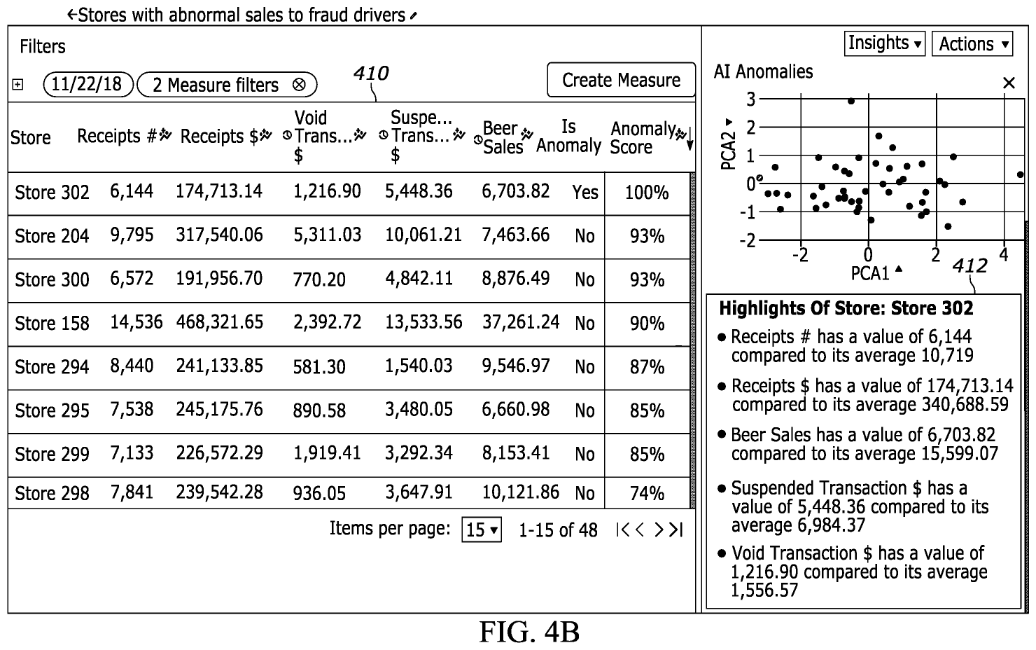

At block 106, the dataset may be input to a machine learning model to detect one or more anomalies in the dataset. The machine learning model may be an unsupervised neural network, such as an autoencoder neural network, and may be trained in real-time on data. The machine learning model may receive data and analyze the data to determine a rule for the dataset, then reconstruct the dataset based on the rule. A machine learning model may determine whether there is an anomalous item, (e.g., a caught item) present for a given dimension. For example, in FIG. 4A, Cashier 488(63) is noted as having an anomaly in the “Is Anomaly” column (“Yes”). The machine learning model may also determine a percent score for how similar a datapoint within the original dataset provided to the machine learning model is to the corresponding datapoint in the reconstructed dataset returned by the machine learning model, e.g. an anomaly score. For example, in FIG. 4A, the anomaly score for Cashier 488(63) is 100%.

At block 108, the user may select a set of anomaly parameters for filtering the output of the machine learning model, such that only data of interest is displayed and/or saved and/or used for further analysis. The anomaly parameters may include an indication of an anomaly (“anomaly yes/no”), an anomaly score (“anomaly score 0-100%”), and a first and second principal component of a principal component analysis (“PCA1 and PCA2”). The user may filter the dataset output by the machine learning model according to one or more anomaly parameters to narrow the dataset output by the machine learning model.

At block 110, a set of instructions (e.g., a pattern) for identifying anomalous items may be generated. The set of instructions is a continuous and autonomous pattern for scanning a dataset for anomalies responsive to updates to the dataset. The set of instructions may be based on the set of data parameters, the set of anomaly parameters, and the set of detection pattern parameters. The set of data parameters define the dataset that the machine learning model is to analyze for anomalies. The anomaly parameters are used to filter the dataset output by the machine learning model such that the pattern scans a dataset for members fitting the anomaly detection criteria.

The user may select a set of detection pattern parameters to further define the set of instructions for anomaly detection. The set of detection pattern parameters may include a time frame indicating which values to include in a second dataset, a schedule for further anomaly detection, one or more prescriptive actions associated with the one or more anomalous items, a security level associated with the one or more anomalous items, and/or a responsibility level associated with the one or more anomalous items. The time frame indicates which values to include in the dataset to be analyzed, e.g., the past 7 days, the past 30 days, etc. The schedule for anomaly detection includes the frequency of executing anomaly detection, e.g., daily, monthly, after a set number of occurrences etc., and may include a start date and an end date for executing anomaly detection. The schedule may also include the type of calendar on which the anomaly detection is run, and whether anomaly detection is run automatically or at a specific time. The prescriptive actions include information about the anomaly, why a value is anomalous, and what actions to take in response to detecting an anomaly to correct the anomaly. The security level may indicate which users are allowed to access information about and/or take action in response to the anomaly. The responsibility level may indicate which users are responsible for taking action in response to the anomaly.

At block 112, the set of instructions may be executed to detect anomalous items within the system (e.g., caught items).

At block 114, anomalous items may be transmitted to users based on security or responsibility for the one or more anomalous items. The user responsible for handling the caught item may be provided with information about the one or more anomalous items. Such information may include an opportunity or task for the item that provides an explanation of the anomaly and/or reason for the pattern for anomaly detection, a reason for why the item has been flagged, and/or a prescriptive action (i.e., corrective action) to take in response to the anomalous item. Analytical views and other data visualizations may be displayed to provide more information about the anomaly. In some embodiments, the prescriptive actions may be communicated to an external task management system. In some embodiments, the prescriptive actions communicated to the external task management system may not include any data identifying the anomalous items, such that a user of the external task management system may not be able to view details such as a reason an item is anomalous.

FIGS. 2A-2B illustrate selecting a set of data parameters indicating a dataset the system intends to analyze, and retrieving the dataset from a database.

FIG. 2A depicts a combined block and flow diagram of an example of retrieving a dataset from a database. A set of data parameters may be used to create a query request 202, which then undergoes validation at block 204. The set of data parameters may then be translated to a query definition at block 206 which may used to generate a query in a programming language for storing and processing information in a relational database at block 208. For example, in FIG. 2A, the programming language is SQL, though other database languages may be used. A semantic layer 210 may map different terms used by different parts of a company that refer to the same thing to one data entity for a single view of the data, and other applications may be used to allow for analysis and viewing of data for users who are less familiar with database programming languages. At block 212, the query may be executed to retrieve data from a database 214, such as Google Big Query. The results (i.e., a dataset) may be parsed at block 216 and returned to the user.

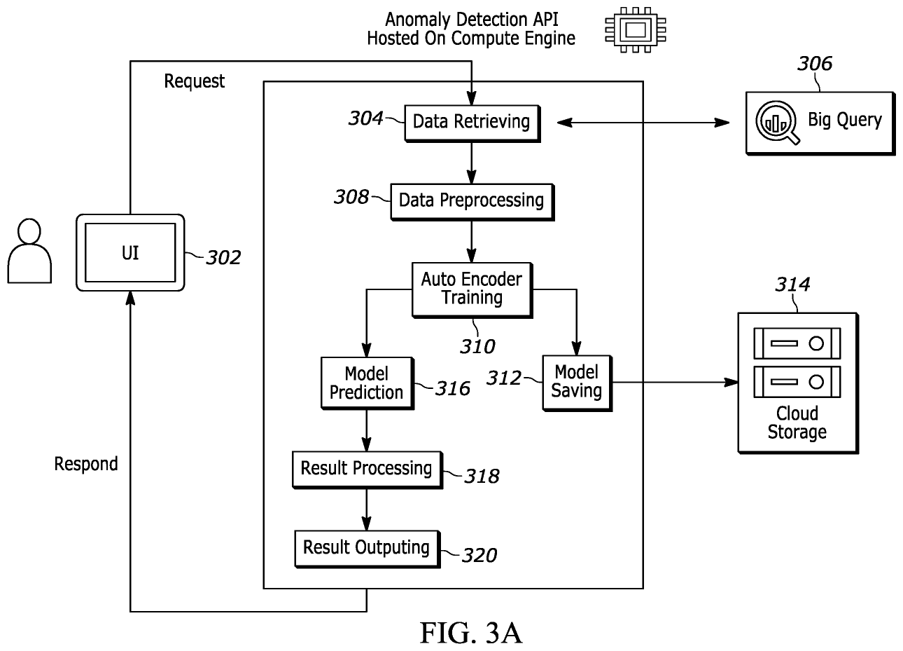

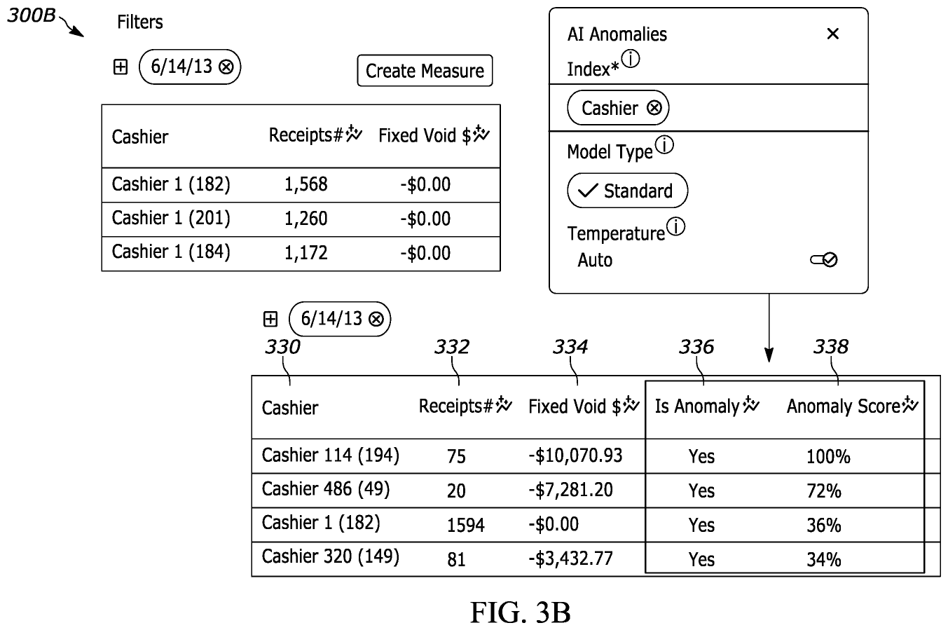

FIG. 2B depicts an example of a dataset retrieved from a database. A dataset is retrieved according to the parameters. Data parameters may include a dimension 220 (i.e., an entity to observe) and measures 222 that are associated with a dimension 220 and may include metrics for the dimension 220. For example in FIG. 2B, a dataset containing data about cashiers 224 (a dimension), and measures including a number of receipts generated by each cashier (receipts #) 226, a dollar amount of voided transactions processed by a particular cashier (fixed void $) 228, a dollar amount of discounts processed by a particular cashier (discount $) 230, and a number of discounted items processed by a particular cashier (discount #) 232 are retrieved from the database in accordance with the selected set of data parameters. FIGS. 3A-3B depict the process of anomaly detection.

As shown in FIG. 3A, a request may be submitted by a user via a user interface such as user interface 302. The request may call an anomaly detection application programming interface (API), for example, stored at the memory of a server providing anomaly detection services such as the memory 926 of the server 904 in FIG. 9. The API may be implemented as an endpoint accessible via a web service protocol, such as representational state transfer (REST), Simple Object Access Protocol (SOAP), JavaScript Object Notation (JSON), etc. After a request has been submitted, data is retrieved from a database 306 at block 304 according to a set of data parameters, as described in FIGS. 2A-2B. The data may be preprocessed at block 308 to transform the data for analysis and input to the machine learning model. For example, the data may be cleaned, normalized, filtered, undergo feature extraction, undergo feature selection, or may be otherwise transformed in preparation for analysis. The preprocessed data may then be input to a machine learning model for training and predictions.

The machine learning model may be trained at block 310. In some embodiments, the machine learning model may be an autoencoder neural network as shown in FIG. 3A. The autoencoder has an encoding function and a decoding function. The encoding function translates the input data into a latent space, thus deriving rules from the dataset. The decoding function reconstructs input data from the latent space based on the rules derived from the encoding step. In some implementations, the autoencoder may be trained in real-time on newly collected and/or updated data. The trained model may be saved in cloud storage at block 314. At block 316, the model may predict anomalous datapoints in the dataset by comparing reconstructed data to the input data to generate an anomaly score. Datapoints from the reconstructed dataset that deviate from the corresponding input datapoint (i.e., have a high anomaly score) are considered anomalous. The results of the prediction are processed at block 318 and the output is transmitted to the user interface 302 at block 320.

The use of an autoencoder offers advantages, such as real-time training on newly updated data. However, other machine learning techniques may be used. For example, the machine learning model may employ various machine learning methods and algorithms such as linear or logistic regression, instance-based algorithms, regularization algorithms, decision trees, Bayesian networks, cluster analysis, association rule learning, artificial neural networks, deep learning, combined learning, reinforced learning, dimensionality reduction, and support vector machines, which may be directed toward one or more categorizations of machine learning, including supervised learning, unsupervised learning, and reinforcement learning.

FIG. 3B depicts an example dataset which is processed to detect anomalies, the results of the anomaly detection, and filtering of such results. For example, as shown in FIG. 3B, a dataset 300B may include a cashier 330, a receipts #332 indicating a number of transaction receipts generated by the corresponding cashier, and a fixed void $ 334 indicating an amount of voided transactions in dollar amounts for the corresponding cashier. The results of anomaly detection output from the machine learning model may include whether there is an anomaly associated with a particular cashier (“Is Anomaly” column 336) and an anomaly score 338 indicating, in the illustrated example, an anomaly assurance percentage. Other example anomaly detection output data from the machine learning model include averages and other statistical values for a measure, and a percent difference between a value for a measure and the average value for a measure. In some implementations, the anomaly detection output data may be graphically displayed. These results (i.e., the anomaly detection output alone or in combination with the input data fed to the anomaly detection system) may also be filtered according to a set of anomaly parameters to narrow the dataset that is shown. Such filtering may occur, for example, after the results of the machine learning model output to filter on the generated output. For example, in FIG. 3B, the results of the machine learning model output have been filtered to only show cashiers that have been flagged as anomalous (“Yes” in the “Is Anomaly” column 336) and an anomaly score indicating how anomalous an item is (“Anomaly Score” column 338).

FIGS. 4A and 4B depict filtering of the results of the anomaly detection process and the reasons for the anomaly. FIG. 4A depicts an example of detecting and filtering cashier anomalies. For example, table 402 shows Cashier 488(63) as having an anomaly detected that is associated with that cashier. Block 404 depicts the reasons for why Cashier 488(63) was flagged as anomalous. For example, Cashier 488(63) had a fixed void $ value (−$6,254.11) that was much higher than the average ($−25.51), and a receipts #value (20) that was much lower than the average (64). While FIG. 4A depicts only one entity that has been flagged as anomalous (i.e., Cashier 488(63)), more than one entity may be anomalous. In some implementations, the reasons for the anomaly may be transmitted to a user computing device and/or task management service. Graph 406 depicts a plot of datapoints in the dataset, with the points noted as either anomalous or not anomalous. Point 408 refers to the fixed void $ value associated with the with the receipts #value of Cashier 488(63). The greater distance of point 408 from the cluster of other datapoints indicate the point 408 is anomalous.

FIG. 4B depicts an example of detecting and filtering store anomalies. For example, table 410 shows Store 302 as having an anomaly detected that is associated with that store. In some implementations, a measure associated with a particular entity may be flagged based on comparison with all other entities in a pool of entities. For example, as shown in block 412, the receipt #value and receipt $ are significantly lower than an average receipts # and receipts $ of the pool of stores. However, the void transaction $ and suspended transaction $ are only marginally below the pool, leading to a 24% difference of void transaction $ and suspended transaction $ when compared to the pool of stores. Beer sales has a largest % difference to the pool and is abnormally low in comparison to the pool. Store 302's receipts #, receipts $, void transaction $, suspended transaction $, and beer sales are thus anomalous when compared to the pool of stores and indicate someone at the store 302 may be giving beer away, or that beer is being stolen. In some implementations, an entity may be flagged as anomalous on real-time, dynamic shifts in data. For example, a pool of entities as a whole may experience real-time, dynamic shifts affecting the measures, such that an entity may be flagged only if measures for that entity, when compared to the pool of entities, are outside the range of the real-time shifts experienced by the pool of entities.

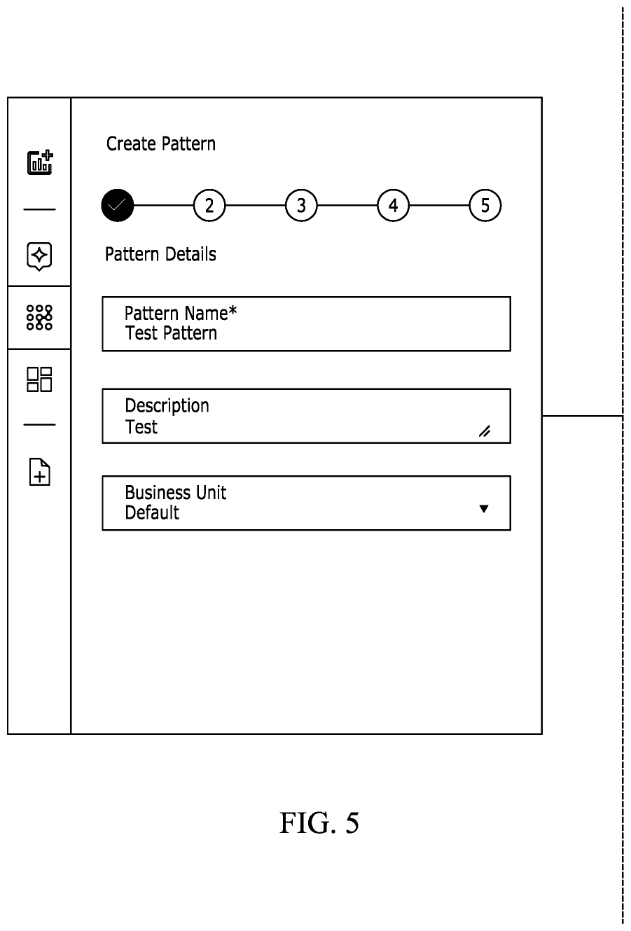

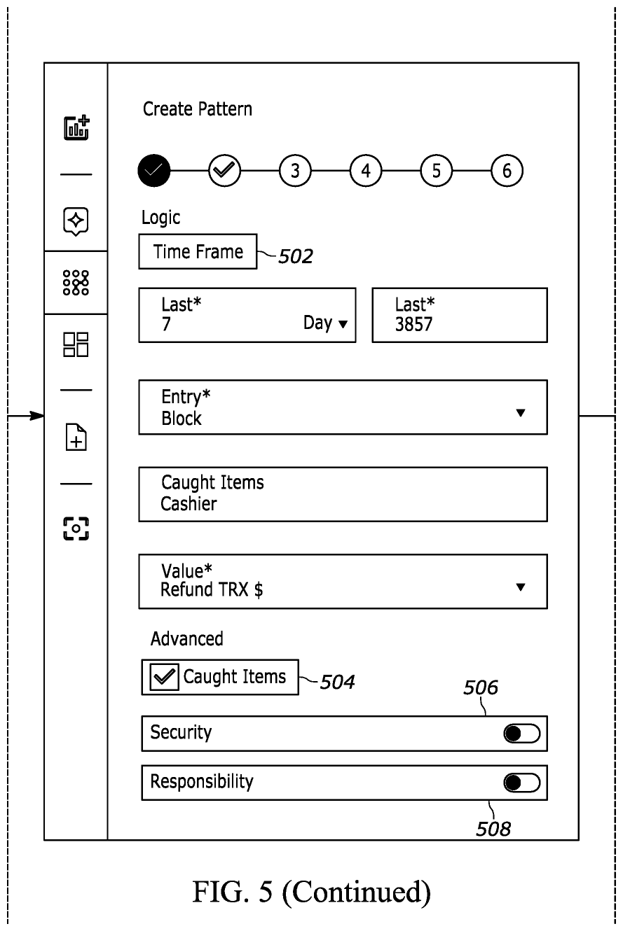

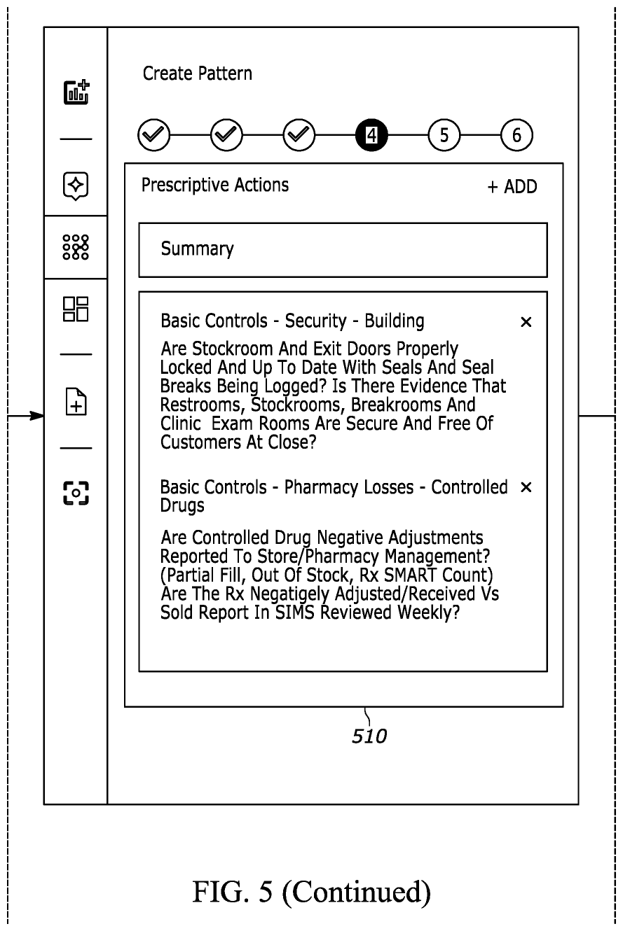

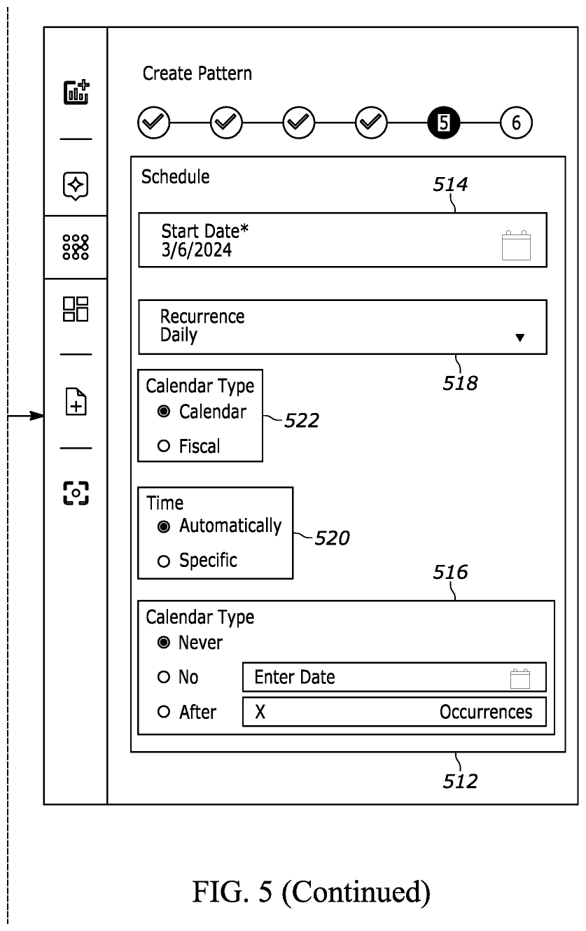

FIG. 5 depicts an example user interface for generating a set of instructions for identifying anomalous items responsive to updates to the dataset. Detection pattern parameters that are used to generate the set of instructions for identifying anomalous items include a time frame 502, whether the item is a caught item 504, whether the caught item should be assigned by security 506 and/or whether the caught item should be assigned by responsibility 508, prescriptive actions 510, and a schedule 512 for executing the instructions for identifying anomalous items. In some embodiments, prescriptive actions may be predetermined and selected by users. In some embodiments, prescriptive actions may be manually entered by the user via the user interface when creating the set of instructions for anomaly detection. The schedule 512 may include a start date 514 and/or an end date 516, a recurrence 518 (e.g., frequency) of anomaly detection, whether the anomaly detection is executed automatically or at a specific time 520, and/or a type of calendar 522 on which the anomaly detection runs. A user may select pattern parameters via a user interface.

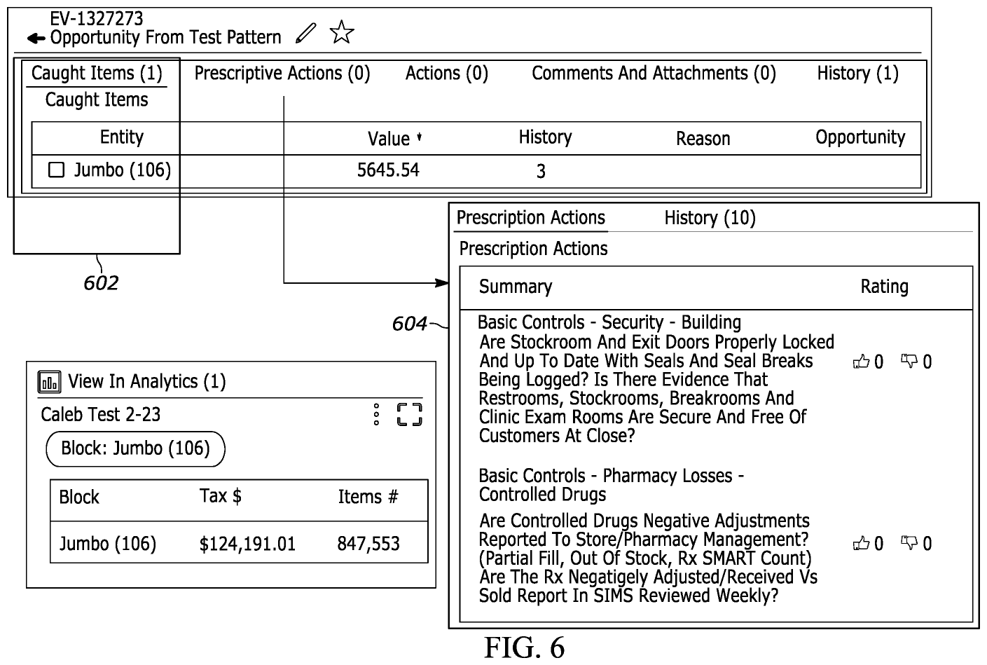

FIG. 6 depicts a user interface of a transmitted caught item 602 and prescriptive actions 604 to the appropriate user for handling the actions. The prescriptive action may be sent to a user based on responsibility and/or security. In some implementations, reasons for why the caught item is anomalous may be included.

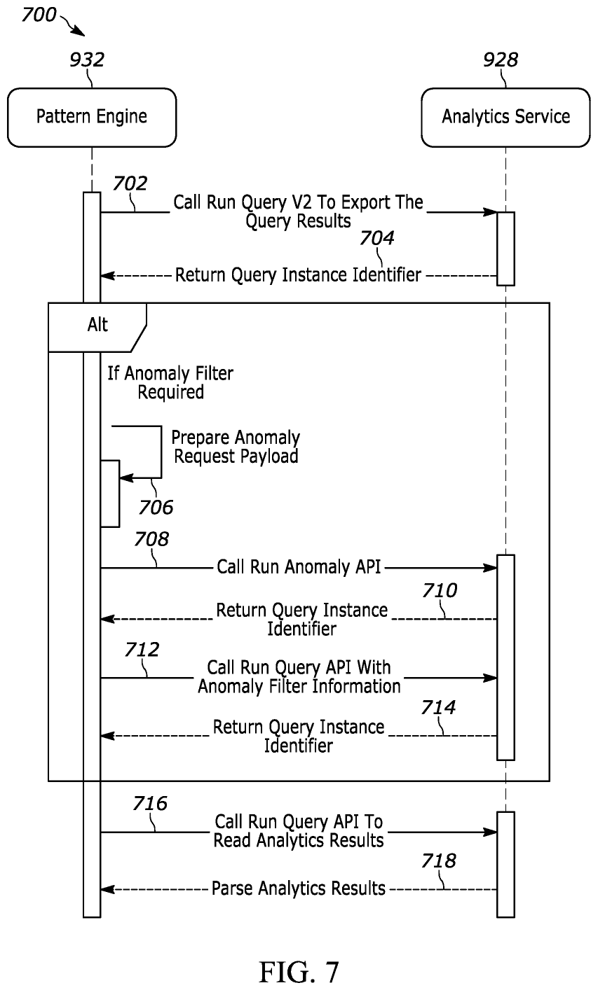

FIG. 7 depicts a sequence diagram for a sequence 700 associated with executing a set of instructions for identifying anomalous items in real-time (i.e., pattern execution), as may be executed by a specific example implementation of the pattern engine and analytics service stored on the memory of a server such as the pattern engine 932 and analytics service 928 stored in the memory 926 of server 904 of FIG. 9. The sequence 700 includes a timeline of events affecting a pattern engine 932 and an analytics service 928.

Sequence 700 may begin at step 702, when a pattern engine 932 exports a data set to be analyzed to the analytics service 928 (“Call RunQuery V2 to export the query results”). At step 704, the analytics service returns a query instance identifier in response to the request from pattern engine 932.

At step 706, the pattern engine 932 may prepare a payload for a request to filter the results of the anomaly detection with anomaly parameters if the pattern includes such filtering.

At step 708, the pattern engine 932 calls an API (“Run Anomaly API”) to run the set of instructions to identify anomalies. The API may be implemented as an endpoint accessible via a web service protocol, such as representational state transfer (REST), Simple Object Access Protocol (SOAP), JavaScript Object Notation (JSON), etc. The analytics service 928 uses the machine learning model, as described above in FIG. 3A, to identify anomalous items and returns a query instance identifier at step 710.

At step 712, the pattern engine calls an API (“RunQuery API”) to transmit a request to the analytics service 928 to filter the output of the machine learning model. The request may include a set of anomaly parameters to filter the data. At a step 714, the analytics server 928 returns a query instance identifier.

At step 716, the pattern engine calls the RunQuery API to request the analytics service 928 to read the analytics results. The analytics service 928 may analyze the identified anomalous items to provide information about the anomalies. For example, the analytics service 928 may determine a reason for why the item was flagged as anomalous and/or prescriptive actions for correcting the anomalous item based on the instructions in the pattern. At a step 718, the analytics service 928 may transmit analytics about the anomaly to the pattern engine 930.

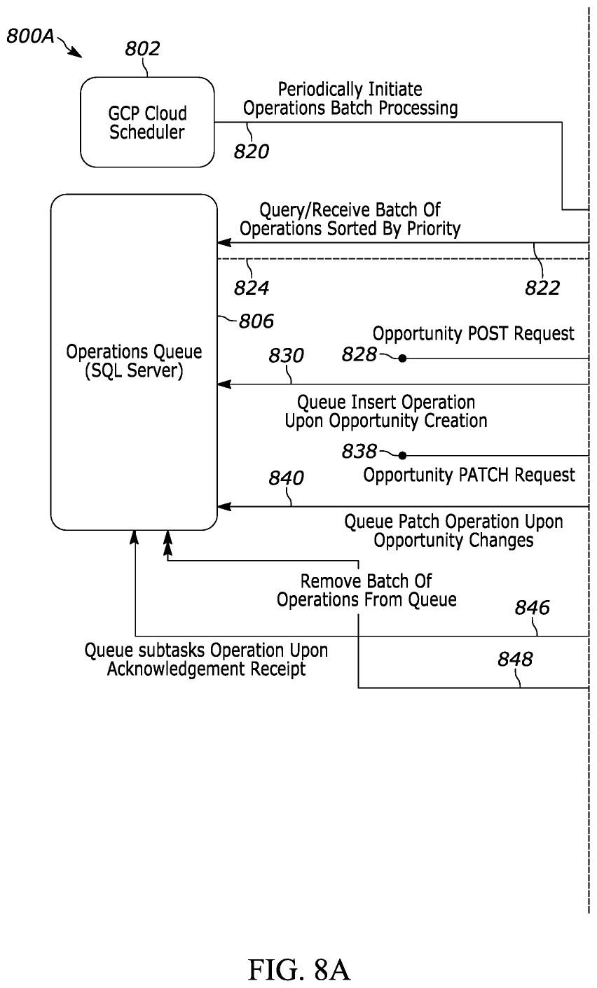

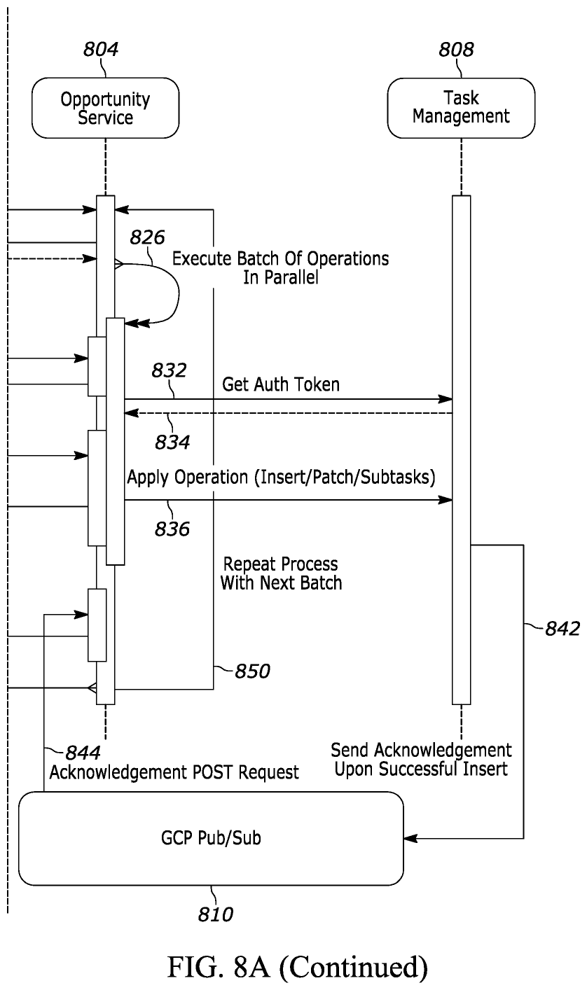

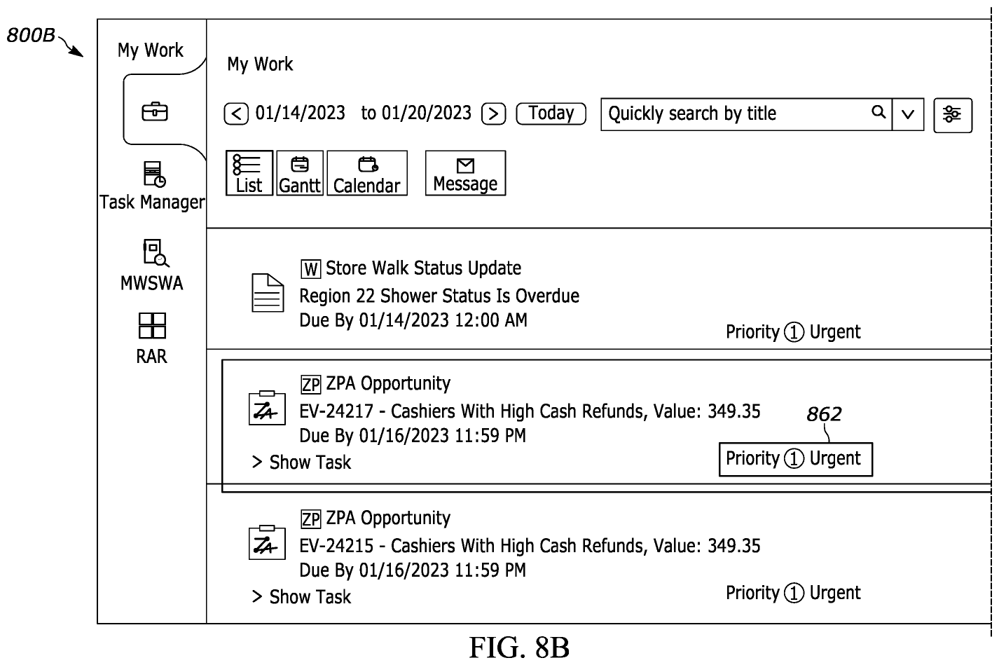

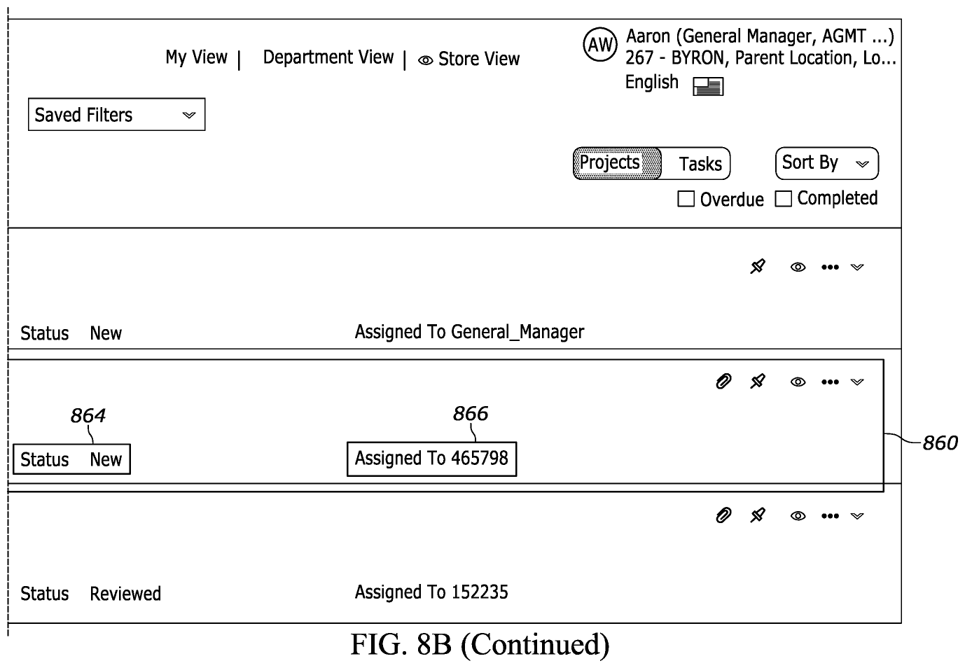

FIGS. 8A-8B depict communicating prescriptive actions to an external task management device.

FIG. 8A depicts a sequence diagram for a sequence 800A associated with communicating prescriptive actions (e.g., opportunity), as may be executed by instructions stored in the memory 926 of the server 904, the task management system 910, and one or more cloud APIs 914, as shown in FIG. 9. The sequence 800A includes a timeline of events affecting a scheduler 802, an opportunity service 804, an operations queue 806, task management 808, and a messaging service 810. The scheduler 802 may schedule jobs and may be a service API such as GCP Cloud Scheduler. The opportunity service 804 may be a service that identifies prescriptive actions for correcting the anomaly and may be part of the analytics service 928 of FIG. 9. The operations queue 806 may be a database server, such as a SQL server, that stores and retrieves operations, such as a database 906 of FIG. 9. Task management 808 may be an external task management system that displays tasks to various users, such as the task management system 910 of FIG. 9. The messaging service 810 may be a messaging service API such as GCP Pub/Sub that facilitates communications from various services and allows for asynchronous communications.

As shown in FIG. 8A, the scheduler 802 may transmit a signal to the opportunity service 804 at step 820 to initiate batch processing of operations. The scheduler 802 may periodically initiate such processing.

The opportunity service 804 may query the operations queue 806 at step 822 for a batch of operations. The operations may be sorted by priority. At step 824, the opportunity service may receive the requested batch of operations from operations queue 806.

At step 826, the opportunity service 804 may execute the batch of operations to identify opportunities and/or changes and/or updates in opportunities, i.e., identify prescriptive actions and/or changes and/or updates to prescriptive actions to transmit to the external task management 808. Such prescriptive actions may be identified based on a set of instructions for anomaly detection.

At step 828, the messaging service 810 may generate a post request to create the opportunity. At step 830, the opportunity service may transmit an operation associated with the opportunity to the operations queue 806 to be added to the operations queue 806.

At step 832, the opportunity service 804 may transmit a request 832 for an authorization token from task management 808 so that an opportunity may be added to and/or changed in the external task management system 808. At step 834, the opportunity service 804 may receive the authorization token.

At step 836, the opportunity service 804 may transmit the opportunity to task management 808 in a post request. The opportunity and the authorization token may be included in the request.

At step 838, the messaging service 810 may generate a patch request to change and/or update an existing opportunity. At step 840, the opportunity service may transmit an operation associated with the opportunity to the operations queue 806 to change and/or update the existing opportunity in the operations queue 806. The opportunity service 804 may transmit the change and/or update to the existing opportunity at step 836. The request to transmit the change and/or update to the existing opportunity may include the authorization token received from task management 808 at step 834.

At step 842, task management 808 may transmit an acknowledgement that an opportunity has been successfully added to, changed, or updated in task management 808. The acknowledgement may be sent to the messaging service 810. At a step 844, the messaging service may generate and transmit a post request of the acknowledgement to the opportunity service 804.

At step 846, the opportunity service may add any corresponding subtask operations to the operations queue 802 after receiving the acknowledgement from the messaging service 810.

At step 848, the opportunity service may remove the batch of operations from the queue. At a step 850, the operations service may repeat the process with a subsequent batch of operations.

FIG. 8B depicts an example user interface of an external task management system, such as task management 808 in FIG. 8A. As shown in FIG. 8B, a prescriptive action 860, i.e. an opportunity, may be received by the task management service and displayed to the user in the user interface 800B. The prescriptive action 860 may be selected as specified in the set of instructions for anomaly detection. In some embodiments, a prescriptive action may be transmitted to an external task management user interface without any information about the anomalous item, e.g., a reason for the anomaly and/or prescriptive action. For example, a user of the task management interface may see only the action to take to correct the anomaly, but not why the item is anomalous. In some embodiments, information about an anomalous item may be transmitted to the task management interface such that a user of the task management interface may be able to view the information regarding the anomalous item. In some embodiments, the amount of information about an anomalous item transmitted to the task management interface depends on a security level and/or responsibility level. In some embodiments, the prescriptive action may include a priority level 862, a status 864, and user identifier 866 of the user to whom the prescriptive action is assigned.

FIG. 9 is a block diagram of an example system that may be used to implement the various systems and methods for identifying a source of an anomaly. The system of FIG. 9 may include one or more store computing devices 902, a server 904, one or more databases 906, one or more user devices 908, and an external task management system 910. The computing system may further include one or more cloud application programming interfaces (APIs) 914. The store computing devices 902, the server 904, the databases 906, and the user devices 908 may be communicatively coupled via a network 912.

The store computing devices 902 may be various computing devices located at a store. The store computing devices 902 may be devices such as smart phones, tablets, desktop computers, cash registers, or other devices that are used in the operation of the store. Each of the user devices 908 may include a processor and a memory (not depicted) including instructions that, when executed, cause the store computing devices 902 to gather data associated with the operation of the store. The store computing devices may transmit collected data to other components of the system 900, such as the server 904 or database 906.

The server 904 of FIG. 9 may include one or more processors 920, one or more network interfaces 924, and one or more memories 926. The one or more memories 926 may have stored thereon an anomaly detector/analytics service module 928 (e.g., one or more sets of instructions for detecting anomalies from data gathered by the store computing devices 902) and a pattern engine 932 (e.g., one or more sets of instructions for generating a set of instructions for anomaly detection). In some aspects, the memories 926 may include additional modules and/or services for receiving and processing data from one or more other components of the system 900 such as the one or more cloud APIs 914, one or more store computing devices 902, one or more user devices 908, the databases 906, and/or the external task management system 910.

The processors 920 of the illustrated example may be implemented using hardware, and may include a semiconductor based (e.g., silicon-based) device. The processors 920 may be, for example, one or more programmable microprocessors, controllers, digital signal processors (DSP), graphics processing units (GPU) and/or any suitable type of programmable processor capable of executing instructions to, for example, implement operations of the example methods described herein. Additionally or alternatively, the processors 920 may be a field programmable gate array (FPGA), an application specific integrated circuit (ASIC,) etc. that implements operations of the example methods described herein without executing instructions.

The example server 904 of FIG. 9 includes one or more communication interfaces such as, for example, the one or more network interfaces 924. The communication interface(s) 924 enable the server 904 of FIG. 9 to communicate with, for example, another device, system, etc. (e.g. store computing devices 902, database 906, user device 908), any other database, and/or any other machine.

The example server 904 of FIG. 9 includes the network interface(s) 924 to enable communication with other machines via, for example, one or more networks such as the network 912. The example network interfaces 924 include any suitable type of communication interface(s) (e.g., wired and/or wireless interfaces) configured to operate in accordance with any suitable communication protocol(s). Example network interfaces 924 include a TCP/IP interface, a WiFi™ transceiver (e.g., according to the IEEE 802.11x family of standards), an Ethernet transceiver, a cellular transceiver, a satellite transceiver, an asynchronous transfer mode (ATM) transceiver, a digital subscriber line (DSL) modem, a coaxial cable modem, a dialup modem, or any other suitable interface based on any other suitable communication protocols or standards.

The memories 926 may include volatile and/or non-volatile storage media. For example, the memories 926 may include one or more random access memories, one or more read-only memories, one or more cache memories, one or more hard disk drives, one or more solid-state drives, one or more non-volatile memory express, one or more optical drives, one or more universal serial bus flash drives, one or more external hard drives, one or more network-attached storage devices, one or more cloud storage instances, one or more tape drives, etc.

As noted, the memories 926 may have stored thereon an anomaly detection/analytics service module 928, for example, as one or more sets of computer-executable instructions for implementing methods for identifying one or more anomalies. The anomaly detection/analytics service module 928 may be implemented using any suitable computer programming language(s) (e.g., Python, JavaScript, C, C++, Rust, C #, Swift, Java, Go, LISP, Ruby, Fortran, etc.). The anomaly detection/analytics service module 928 may include one or more submodules, including a machine learning module 930.

The machine learning module 930 may include instructions for detecting anomalies in a dataset created from data collected from store computing devices 902. In some implementations, the machine learning module 930 may include instructions for preprocessing the dataset in preparation for input to a machine learning model. The machine learning module 930 may include further instructions for the training and operation of a machine learning model. For example, as discussed above, the present techniques may include training an autoencoder in real-time and using the autoencoder to detect anomalies on a dataset created from data collected from store computing devices 902.

The memories 926 may have stored thereon a pattern engine 932, for example, as one or more sets of computer-executable instructions for generating and executing a set of instructions for anomaly detection on an updated dataset, i.e., a pattern. The pattern engine 932 may be implemented using any suitable computer programming language(s) (e.g., Python, JavaScript, C, C++, Rust, C #, Swift, Java, Go, LISP, Ruby, Fortran, etc.). The pattern engine may communicate with the anomaly detection/analytics service module 928 to instruct the anomaly detection/analytics service module 928 to detect anomalies on a dataset.

In some examples, the server 904 also includes, or is otherwise communicatively coupled to, one or more databases 906 or other data storage mechanisms (one or more of a HDD, optical storage drive, solid state storage device, CD, CD-ROM, DVD, Blu-ray disk, RAID, data storage bank, etc.). In some examples, the databases 906 may be cloud databases that are accessible via the cloud APIs 914.

The server 904 may communicate with the user devices 908. The user devices may be devices such as smart phones, tablets, desktop computers, etc. The user devices may be used to interact with the server 904. Each of the user devices 908 may include a processor and a memory (not depicted) including instructions (e.g., instructions corresponding to an application) that, when executed, cause information received from the server 904, such as detected anomalous items, to be displayed on the user devices 908.

In some examples, the server 904 may communicate with an external task management system 910 via the network 912. The external task management system 910 may include instructions to cause user devices 908 to display information associated with an anomalous item. The external task management system 910 may be implemented on another server (not depicted). In some examples, the external task management system 910 may be a cloud application. The external task management system 910 may include one or more APIs (not depicted) for enabling one or more other components within the environment 900 to access functionality of the external task management system 910, for example, to receive opportunities (i.e., tasks) from other components within the environment 900.

In some embodiments, the user device 902 and/or the server 904 may offload some or all of their respective functionality to the one or more cloud APIs 914. In aspects, the one or more cloud APIs 914 may include one or more public clouds, one or more private clouds and/or one or more hybrid clouds. The one or more cloud APIs 914 may include one or resources provided under one or more service models, such as Infrastructure as a Service (IaaS), Platform as a Service (PaaS), Software as a Service (SaaS), and Function as a Service (FaaS). For example, the one or more cloud APIs 914 may include one or more cloud computing resources, such as computing instances, electronic databases, operating systems, email resources, etc. The one or more cloud APIs 914 may include distributed computing resources that enable, for example, communication of tasks between the server 904, the database 906, and the task management system 910. In some aspects, the one or more cloud APIs 114 may include APIs such as GCP Cloud Scheduler, GCP Pub/Sub, etc.

### Additional Considerations

The various embodiments described above can be combined to provide further embodiments. All U.S. patents, U.S. patent application publications, U.S. patent application, foreign patents, foreign patent application and non-patent publications referred to in this specification and/or listed in the Application Data Sheet are incorporated herein by reference, in their respective entireties, for all purposes. Implementations of the embodiments can be modified if necessary to employ concepts of the various patents, applications, and publications to provide yet further embodiments.

These and other changes can be made to the embodiments in light of the above-detailed description. In general, in the following claims, the terms used should not be construed to limit the claims to the specific embodiments disclosed in the specification and the claims but should be construed to include all possible embodiments along with the full scope of equivalents to which such claims are entitled. Accordingly, the claims are not limited by the disclosure.

The following considerations also apply to the foregoing discussion. Throughout this specification, plural instances may implement operations or structures described as a single instance. Although individual operations of one or more methods are illustrated and described as separate operations, one or more of the individual operations may be performed concurrently, and nothing requires that the operations be performed in the order illustrated. These and other variations, modifications, additions, and improvements fall within the scope of the subject matter herein.

It should also be understood that, unless a term is expressly defined in this patent using the sentence “As used herein, the term” “is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. § 112(f).

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one implementation” or “an implementation” means that a particular element, feature, structure, or characteristic described in connection with the implementation is included in at least one implementation. The appearances of the phrase “in one implementation” in various places in the specification are not necessarily all referring to the same implementation.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of “a” or “an” is employed to describe elements and components of the implementations herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for implementing the concepts disclosed herein, through the principles disclosed herein. Thus, while particular implementations and applications have been illustrated and described, it is to be understood that the disclosed implementations are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A method for anomaly detection, the method comprising:
receiving, via one or more processors, a set of data parameters;
retrieving, via the one or more processors, a dataset corresponding to the set of data parameters from a database;
analyzing, via the one or more processors and using a machine learning model trained in real-time, the dataset to detect one or more anomalies in the dataset;
selecting, via the one or more processors, a set of anomaly parameters corresponding to the detected one or more anomalies;
filtering, via the one or more processors, an output of the machine learning model according to the set of anomaly parameters;
generating, via the one or more processors, a set of instructions for identifying one or more anomalous items based on the set of data parameters, the set of anomaly parameters, and a set of detection pattern parameters;
executing, via the one or more processors, the set of instructions for identifying anomalous items to identify one or more anomalous items in real-time within the dataset responsive to updates to the dataset; and
transmitting, via the one or more processors, information about the one or more anomalous items to a user computing device or another computing device.

2. The method of claim 1, wherein the machine learning model is an autoencoder neural network.

3. The method of claim 2, further comprising training the autoencoder neural network in real-time by providing the autoencoder neural network data corresponding to the one or more anomalies in the dataset.

4. The method of claim 3, further comprising training the autoencoder neural network in real-time by providing the autoencoder neural network one or more predefined rules.

5. The method of claim 4, wherein the set of instructions for identifying anomalous items is obtained from an external server communicatively accessible by the one or more processors over a network.

6. The method of claim 1, wherein the machine learning model is an unsupervised neural network, the method further comprising training the unsupervised neural network in real-time by providing the unsupervised neural network data corresponding to the one or more anomalies in the dataset.

7. The method of claim 1, wherein the set of detection pattern parameters include one or more of: (i) a time frame indicating which values to include in a second dataset, (ii) a schedule for further anomaly detection, (iii) one or more prescriptive actions associated with the one or more anomalous items, (iv) a security level associated with the one or more anomalous items, and/or (v) a responsibility level associated with the one or more anomalous items.

8. The method of claim 7, wherein the information about the one or more anomalous items includes one or more of (i) an explanation of an anomaly affecting the one or more anomalous items and/or (ii) a prescriptive action to correct the one or more anomalous items.

9. The method of claim 7, wherein transmitting the information about the one or more anomalies to the user interface includes transmitting the information based one or more of (i) the security level and/or (ii) the responsibility level.

10. The method of claim 9, wherein transmitting the information about the one or more anomalies to the user device or the another computing device includes:
identifying at least one data class associated with the one or more anomalous items; and
based on the at least one data class, identifying the security level and/or the responsibility level.

11. The method of claim 9, wherein transmitting the information about the one or more anomalies to the user device or the another computing device includes:
identifying, in the information, scheduler data that comprises a prescriptive action to correct the anomalous item and identification of an external task management system to receive the prescription action.

12. The method of claim 11, further comprising:
communicating, from the one or more processors, to the external task management system the prescriptive action, wherein the prescriptive action contains no data identifying the one or more anomalous items.

13. The method of claim 1, wherein the anomaly parameters include one or more of: (i) an indication of an anomaly, (ii) an anomaly score, and/or (iii) a first and second principal component of a principal component analysis.

14. The method of claim 1, further comprising analyzing, via the one or more processors, the dataset to detect one or more anomalies in the data set by applying one or more predefined rules.

15. The method of claim 1, wherein filtering the output of the machine learning model according to the set of anomaly parameters comprises applying predetermined anomaly parameter rules in real-time.

16. The method of claim 1, wherein filtering the output of the machine learning model is performed according to explanation data characterizing the one or more anomalies.

17. The method of claim 16, wherein the explanation data is generated by a trained machine learning model.

18. A system for anomaly detection, the system comprising:
one or more processors, and
one or more memories having stored thereon computer-executable instructions that, when executed by the one or more processors, cause the computing system to:
receive a set of data parameters;
retrieve a dataset corresponding to the set of data parameters from a database;
analyze, using a machine learning model trained in real-time, the dataset to detect one or more anomalies in the dataset;
select a set of anomaly parameters corresponding to the detected one or more anomalies;
filter an output of the machine learning model according to the set of anomaly parameters;
generate a set of instructions for identifying one or more anomalous items based on the set of data parameters, the set of anomaly parameters, and a set of detection pattern parameters;
execute the set of instructions for identifying anomalous items to identify one or more anomalous items in real-time within the dataset responsive to updates to the dataset; and
transmit information about the one or more anomalous items to a user computing device or another computing device.

19. The system of claim 18, wherein the machine learning model is an autoencoder neural network.

20. The system of claim 19, the one or more memories having stored thereon computer-executable instructions that, when executed by the one or more processors, further cause the computing system to:
train the autoencoder neural network in real-time by providing the autoencoder neural network data corresponding to the one or more anomalies in the dataset.

21. The system of claim 20, the one or more memories having stored thereon computer-executable instructions that, when executed by the one or more processors, further cause the computing system to:
train the autoencoder neural network in real-time by providing the autoencoder neural network one or more predefined rules.

22. The system of claim 21, wherein the set of instructions for identifying anomalous items is obtained from an external server communicatively accessible by the one or more processors over a network.

23. The system of claim 18, wherein the machine learning model is an unsupervised neural network, the method further comprising training the unsupervised neural network in real-time by providing the unsupervised neural network data corresponding to the one or more anomalies in the dataset.

24. The system of claim 18, wherein the set of detection pattern parameters include one or more of: (i) a time frame indicating which values to include in a second dataset, (ii) a schedule for further anomaly detection, (iii) one or more prescriptive actions associated with the one or more anomalous items, (iv) a security level associated with the one or more anomalous items, and/or (v) a responsibility level associated with the one or more anomalous items.

25. The system of claim 24, wherein the information about the one or more anomalous items includes one or more of (i) an explanation of an anomaly affecting the one or more anomalous items and/or (ii) a prescriptive action to correct the one or more anomalous items.

26. The system of claim 24, wherein transmitting the information about the one or more anomalies to the user device or the another computing device includes transmitting the information based one or more of (i) the security level and/or (ii) the responsibility level.

27. The system of claim 26, wherein transmitting the information about the one or more anomalies to the user device or the another computing device includes:
identifying at least one data class associated with the one or more anomalous items; and
based on the at least one data class, identifying the security level and/or the responsibility level.

28. The system of claim 26, wherein transmitting the information about the one or more anomalies to the user interface includes:
identifying, in the information, scheduler data that comprises a prescriptive action to correct the anomalous item and identification of an external task management system to receive the prescription action.

29. The system of claim 28, the one or more memories having stored thereon computer-executable instructions that, when executed by the one or more processors, further cause the computing system to:
communicate to the external task management system the prescriptive action, wherein the prescriptive action contains no data identifying the one or more anomalous items.

30. The system of claim 18, wherein the anomaly parameters include one or more of: (i) an indication of an anomaly, (ii) an anomaly score, and/or (iii) a first and second principal component of a principal component analysis.

31. The system of claim 18, the one or more memories having stored thereon computer-executable instructions that, when executed by the one or more processors, further cause the computing system to:
analyze the dataset to detect one or more anomalies in the data set by applying one or more predefined rules.

32. The system of claim 18, wherein filtering the output of the machine learning model according to the set of anomaly parameters comprises applying predetermined anomaly parameter rules in real-time.

33. The system of claim 18, wherein filtering the output of the machine learning model is performed according to explanation data characterizing the one or more anomalies.

34. The system of claim 33, wherein the explanation data is generated by a trained machine learning model.
